(19) United States
(12) Patent Application Publication
(10) Pub. No.: US 2005/0276908 A1
(43) Pub. Date: Dec. 15, 2005

(54) Thin film coating device, thin film coating method, immersion exposure device, and immersion exposure method

(75) Inventors: Masaki Kitabata, Toyama (JP); Shinichi Imai, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/101,625

(22) Filed: Apr. 8, 2005

(30) Foreign Application Priority Data
Jun. 11, 2004 (JP) 2004-173518

(51) Int. Cl. B05D 1/12; B05C 11/00

(52) U.S. Cl. 427/8; 427/180; 118/303; 118/665; 118/688

(57) ABSTRACT

Liquid supplied from a delivery source of the liquid through a particle filtering unit is discharged onto the surface of a wafer from a discharge nozzle. A particle measurement unit for measuring the number of particulate matters such as bubbles and particles included in the liquid is provided in a pipe that connects the particle filtering unit and the discharge nozzle. There are further provided a data collecting unit for collecting all time a control voltage value of a solenoid control valve that opens/closes the pipe and a measured value of the particle measurement unit, and an arithmetic unit for performing calculation of the measured result of the particle measurement unit. The arithmetic unit calculates the number of particulate matters included in the liquid to be applied on the wafer as a unit and compares the thus calculated number of the particulate matters with a standard value to judge whether or not a thin film coating apparatus is to be stopped.

### CROSS REFERENCE TO RELATED APPLICATIONS

This Non-provisional application claims priority under 35 U.S.C. § 119(a) on Patent Application No. 2004-173518 filed in Japan on Jun. 11, 2004, and Patent Application No. 2005-015180 filed in Japan on Jan. 24, 2005, the entire contents of which are hereby incorporated by reference.

### BACKGROUND ART

The present invention relates to a thin film coating apparatus and an immersion exposure apparatus which are used for forming a resist pattern on a wafer in manufacturing a semiconductor wafer.

Conventional photolithography processes for manufacturing a semiconductor wafer include the steps of: 1) a resist application step of forming a resist film having uniform thickness by applying a photoresist on the surface of a wafer; 2) a pre-baking step of hardening the resist film by evaporating a solvent mixed in the photoresist to increase adhesiveness to an underlying substance and to enhance photochemical reactivity; 3) an exposure step of irradiating ultraviolet rays on the wafer through a photomask to print a device pattern on the resist; 4) a development step of dissolving an unexposed part of the photoresist by developer to form a pattern of the photoresist; and 5) a post-baking step of hardening the photoresist, which is swelled by the development, to increase the adhesiveness to the underlying substance. In recent years, in association with pattern miniaturization, an additional step is carried out for forming an anti-reflection coating on the photoresist as 6) an application step. In general, in application of chemical solution to be photoresist films, anti-reflection coatings and the like, a method of dropping the chemical solution while rotating the wafer is employed (see Japanese Patent Application Laid Open Publication No. 7-320999A, for example).

FIG. 10 schematically shows a construction of a conventional thin film coating apparatus. As shown in FIG. 10, the conventional thin film coating apparatus includes: a wafer rotating mechanism 102 for holding horizontally and rotating a wafer 101, and a chemical solution application mechanism 104 for conveying and dropping a chemical solution 103. The wafer rotating mechanism 102 is provided with a wafer chuck 105 and a motor flange 106. In the chemical solution application mechanism 104, a discharge nozzle 107 for dropping the chemical solution 103 onto the wafer 101 communicates with a chemical solution bottle 108 serving as a delivery source of the chemical solution 103 through a pipe 109. In the midway points of the pipe 109, a buffer tank 110, a pump 111, a particle filtering unit 112, a solenoid control valve 113, and a chemical solution level adjustment unit 114 are provided in this order when viewed from the chemical solution bottle 108. A control unit 118 controls the chemical solution application mechanism 104.

When the operation of the thin film coating apparatus starts, the chemical solution bottle 108 retaining the chemical solution 103 is placed at a predetermined position and the pipe 109 and a N₂ gas pressure pipe 115 are connected to the chemical solution bottle 108 under a sealed state. Then, N₂ gas pressure is applied through the N₂ gas pressure pipe 115 and a valve of a buffer tank drain 116 is opened so that the chemical solution 103 is filled up to the buffer tank 110. Thereafter, the valve of the buffer tank drain 116 is closed and a valve of a drain 117 of the particle filtering unit 112 is opened so that the chemical solution 103 is filled up to the pump 111 and the particle filtering unit 112. Driving the pump 111 under this state causes the chemical solution 103 to reach the discharge nozzle 107 via the chemical solution level adjustment unit 114. The chemical solution 103, which reaches the discharge nozzle 107, is dropped on the rotating wafer 101, thereby being applied thereon uniformly by centrifugal force. During the series of this processes, an amount of particulate matters (hereinafter referred to as particles) such as bubble, minute dust (particulates) included in the chemical solution 103 is measured by a particle measurement unit 119. The particles diffuse or scatter ultraviolet rays used for irradiation in the exposure step of printing the device pattern on the resist by irradiating the ultraviolet rays to the waver 101 through the photomask. The diffusion and the confusion may cause defects of the device pattern on the wafer 101, resulting in lowered yield. For preventing this disadvantage, the state of the thin film coating apparatus is checked from the a measured result of the particle measurement unit 119 and whether or not the thin film coating apparatus is operated or stopped is judged based on the measured result, so that the thin film coating apparatus is controlled in accordance with the judged result. The aforementioned technique enables to send a signal such as an alarm signal to an operator and to stop the coating operation automatically in the case where particles enter by disturbance such as equipment trouble. As a result, significant damage by lowered yield can be avoided (see Japanese Patent Application Laid Open Publication No. 10-240897A, for example).

However, the thin film coating apparatus as described above involves the following two problems.

In general, for processing one wafer 101, the rotation of the wafer is continued during the time when a given amount of chemical solution is discharged and dropped one time and until the chemical solution 103 comes to have uniform thickness even after discharge of the chemical solution 103 stops. For this reason, the discharge of the chemical solution 103 is actually discontinuous in the aforementioned series of the processes. On the other hand, the particle measurement unit 119 that performs all time measurement uses, as a measured value, an integrated value of the number of particles included in the chemical solution 103 passing through the particle measurement unit 119 per a given time period (per second, for example), regardless of whether or not the chemical solution 103 is being discharged. In this connection, the total number of the particles in the chemical solution 103 to be discharged and dropped on one wafer 101 is an integrated value of the number measured by the particle measurement unit 119 which is measured during the discharge of the chemical solution 103 on the wafer 101. Without exact time of discharge and of stop of the chemical solution 103, the integrated value cannot be obtained and the exact total number of particles in the chemical solution 103 to be discharged and dropped on one wafer 101 cannot be obtained.

Further, with apparatuses having some constitutions or mechanisms, the particle measurement unit 119 is difficult to be arranged at the discharge nozzle 107 and must be arranged in a midway point of the line. For this reason, particles in the chemical solution 103 immediately before drop on the wafer 101 cannot be measured. Specifically, as shown in FIG. 10, the chemical solution 103 including particles detected by the particle measurement unit 119 flows from the particle measurement unit 119, passes through the solenoid control valve 113, the chemical solution level adjustment unit 114, the discharge nozzle 107, and the pipe 109 that connects them, and then, is dropped on the wafer 101. In this connection, the chemical solution 103 under detection in the particle measurement unit 119 is not discharged on the wafer 101 being subjected to processing at that time and is discharged on the wafer 101 after several-time discharge. As described above, there is an interval by an amount of the capacity between the particle measurement unit 119 and the discharge nozzle 107. Therefore, it is necessary to calculate the number of particles included in the chemical solution 103 to be discharged on each wafer 101, taking account of the interval by an amount of the total capacity between the particle measurement unit 119 and the discharge nozzle 107.

### SUMMARY OF THE INVENTION

The present invention has its object of forming a no-defect, high-quality resist pattern by providing means for more exactly grasping the number of particles included in a chemical solution or liquid and means for surely removing bubbles.

A thin film coating apparatus of the present invention is an apparatus for forming a thin film in such a manner that a chemical solution supplied from a delivery source of the chemical solution through a particle filtering unit is discharged from a discharge nozzle so as to be applied on a surface of a wafer, and includes: a pipe that connects the particle filtering unit and the discharge nozzle; a solenoid control valve that opens/closes the pipe; a particle measurement unit that measures a number of particulate matters included in the chemical solution in the pipe; a data collecting unit that collects a control voltage value of the solenoid control valve and a measured value of the particle measurement unit; and an arithmetic circuit that calculates a number of the particulate matters included in the chemical solution to be applied on the wafer as a unit from the control voltage value and the measured value which are collected in the data collecting unit.

It is noted that in the thin film coating apparatus of the present invention, information on a time-varying voltage value that indicates the flow state of the chemical solution to be measured is used as the control voltage value of the solenoid control valve. Also, the arithmetic circuit has a function of judging the flow state of the chemical solution from the control voltage value of the solenoid control valve and calculating the total number of particles in the chemical solution to be discharged in one time from a time period and the measured value of the particle measurement unit during when the chemical solution flows.

In the thin film coating apparatus of the present invention, the number of particulate matters included in the chemical solution to be applied on one wafer as a unit is calculated, so that whether to stop the thin film coating apparatus can be judged based on the calculated value. Specifically, in the case where many particles and bubbles are included in the chemical solution accidentally by disturbance such as equipment trouble and such chemical solution flows in a chemical solution line, the thin film coating apparatus can be stopped automatically. Hence, a defective pattern of a resist can be prevented from being formed.

Further, the particulate matters in the chemical solution can be measured in real time during the product processing, thereby enabling automatic judgment of normal/abnormal states of the apparatus in all time. In comparison with the conventional cases where after forming a thin film on a monitor wafer, particulate matters in the film is measured by a surface defect inspection system or the like, the aforementioned apparatus reduces operation time of an operator and improves the yield. Further, the particulate matters in the chemical solution can be measured without interruption of the operation of the apparatus, resulting in increase in availability ratio of the apparatus.

It is preferable that the arithmetic circuit compares the number of the particulate matters included in the chemical solution to be applied on the wafer as a unit with a standard value determined in advance.

A thin film coating method of the present invention uses a thin film coating apparatus for forming a thin film in such a manner that a chemical solution supplied from a delivery source of the chemical solution through a particle filtering unit is discharged from a discharge nozzle so as to be applied on a surface of a wafer, and includes: a step (a) of collecting a control voltage value of a solenoid control valve provided in a pipe that connects the particle filtering unit and the discharge nozzle and judging whether or not the chemical solution is being applied on the surface of the wafer; a step (b) of measuring a number of particulate matters included in the chemical solution flowing in the pipe; a step (c) of calculating a number of the particulate matters included in the chemical solution to be applied on the wafer as a unit based on results of the step (a) and of the step (b); and a step (d) of judging based on a result of the step (c) whether or not the thin film coating apparatus is to be stopped.

In the thin film coating method of the present invention, in the case where many particulate matters are included in the chemical solution accidentally by disturbance such as equipment trouble and such chemical solution flows in a chemical solution line, the thin film coating apparatus can be stopped automatically. Hence, a defective pattern of the resist can be prevented from being formed.

Moreover, the particulate matters in the chemical solution can be measured in real time during the product processing, thereby enabling automatic judgment of normal/abnormal states of the apparatus in all time. Hence, the above method reduces operation time of an operator and improves the yield, in comparison with the conventional methods in which after forming a thin film on a monitor wafer, particulate matters in the film is measured by a surface defect inspection system or the like. Further, the particulate matters in the chemical solution can be measured without interruption of the operation of the apparatus, resulting in increase in availability ratio of the apparatus.

It should be noted that for calculating the number of particulate matters in the chemical solution to be applied on the wafer as a unit, it is preferable to grasp an interval until the chemical solution measured by the particle measurement unit is released from the discharge nozzle actually. More specifically, on what number wafer the chemical solution measured by the particle measurement unit is applied after a wafer being processed at that time is grasped.

In the thin film coating method of the present invention, it is preferable that in the step (d), the judgment is performed by comparing the number of particulate matters included in the chemical solution to be applied on the wafer as a unit with a standard value predetermined in advance, and the comparison of the number of particulate matters included in the chemical solution to be applied on the wafer as a unit with the standard value is continued even after it is judged that the thin film coating apparatus is to be stopped, and the thin film coating apparatus is stopped until it is judged that the number of the particulate matters falls within a normal range. By this method, chemical solution discharge to another region can be continued automatically until the abnormal state returns to the normal state with less number of the particulate matters, resulting in mitigation of the burden on an operator. In comparison with the conventional methods in which a constant amount of a solution is discharged by an operator, a more appropriate amount of the chemical solution is discharged in the present method. Hence, required time for solution discharge can be minimized and the availability ratio is increased.

An immersion exposure apparatus of the present invention is an apparatus for printing a mask pattern on a wafer from a tip end portion of an optical element of a projection optical system with a state that liquid is filled between the tip end portion of the optical element and a surface of the wafer, and includes: a liquid discharge nozzle that supplies the liquid to the surface of the wafer; a pipe that connects a delivery source of the liquid and the liquid discharge nozzle; a solenoid control valve that opens/closes the pipe; a particle filtering unit intervening in the middle of the pipe; and a bubble removal unit which intervenes between the particle filtering unit and the liquid discharge nozzle in the pipe and removes bubbles in the liquid.

In general, particulate matters such as bubbles in liquid on a wafer scatter exposure light, so that a pattern not accorded with a reticle pattern is formed, resulting in pattern defects that may invite yield lowering. In contrast, in the present invention, the bubble removal unit removes bubbles, thereby preventing a pattern defect more surely. Note that the bubble removal unit selectively removes gaseous molecules only, without variation in composition and in flow rate of the liquid invited.

The immersion exposure apparatus of the present invention may further includes: a particle measurement unit which intervenes between the bubble removal unit and the liquid discharge nozzle in the pipe and measures a number of particulate matters included in the liquid; a data collecting unit that collects a control voltage value of the solenoid control valve and a measured value of the particle measurement unit; and an arithmetic circuit that calculates the number of particulate matters included in the liquid to be supplied on the wafer as a unit from the control voltage value and the measured value which are collected in the data collecting unit. With this arrangement, if bubbles enter in the solution accidentally by disturbance such as equipment trouble, the immersion exposure apparatus can be stopped automatically. Further, the particulate matters in the liquid can be measured in real time during the product processing, thereby enabling automatic judgment of normal/abnormal states of the apparatus in all time. The above apparatus reduces operation time of an operator and improves the yield, in comparison with the conventional cases where which a pattern defect is detected by a surface defect inspection system or the like after performing a series of processing of resist coating on a monitor wafer, exposure, and development. Moreover, the particulate matters in the liquid can be measured without interruption of the operation of the apparatus, with a result of increase in availability ratio of the apparatus.

A specific immersion exposure method using an immersion exposure apparatus in the present invention includes: a step (a) of collecting the control voltage value of the solenoid control valve and judging whether or not the liquid is being supplied to the surface of the wafer; a step (b) of measuring the number of particulate matters included in the liquid flowing in the pipe; a step (c) of calculating the number of the particulate matters included in the liquid to be supplied to the wafer as a unit based on results of the step (a) and of the step (b); and a step (d) of judging based on a result of the step (c) whether or not the immersion exposure apparatus is to be stopped.

In the immersion exposure method of the present invention, it is preferable that in the step (d), the judgment is performed by comparing the number of particulate matters included in the liquid to be supplied to the wafer as a unit with a standard value predetermined in advance, and the comparison of the number of particulate matters included in the liquid to be supplied to the wafer as a unit with the standard value is continued even after it is judged that the immersion exposure apparatus is to be stopped, and the immersion exposure apparatus is stopped until it is judged that the number of the particulate matters falls within a normal range. With this arrangement, liquid discharge to the other region can be continued automatically until the abnormal state returns to the normal state with less number of particulate matters, resulting in mitigation of the burden on an operator. In comparison with the conventional cases where a constant amount of liquid is discharged by an operator, a more appropriate amount of the liquid is discharged in the present method. Hence, required time for solution discharge can be minimized and the availability ratio is increased.

### BRIEF DESCRIPTION OF THE DRAWINGS

FIG. 1 is a schematic view illustrating a construction of a thin film coating apparatus in a first embodiment of the present invention.

FIG. 2A to FIG. 2C are time charts showing a flow rate of a chemical solution in a pipe during wafer processing, opened/closed states of a solenoid control valve, and time variation of a control voltage value, respectively, in the first embodiment.

FIG. 3A and FIG. 3B shows the relationship between the opened/closed states of the solenoid control valve and the total number of particles in the chemical solution to be applied on a wafer as a unit in the first embodiment.

FIG. 4 is a graph showing each variation in the total number of the particles in the chemical solution to be applied on a wafer as a unit and in the number of pattern defects on the wafer in the first embodiment.

FIG. 5 is a graph showing a correlation between a measured value of a particle measurement unit and the number of pattern defects on the wafer in the first embodiment.

FIG. 6 is a flowchart depicting steps for controlling the thin film coating apparatus by referencing a standard value in the first embodiment.

FIG. 7 is a graph showing the relationship between particle count in the chemical solution and the number of killer defects in a wafer as a unit in the first embodiment.

FIG. 8 is a schematic view illustrating an immersion exposure apparatus employing an immersion exposure method in a second embodiment.

FIG. 9 is a graph showing the relationship between a sum of the operating time periods of a bubble removal unit and a measured result of the number of particulate matters included in liquid after passing through the bubble removal unit, which is obtained by a particle measurement unit in the immersion exposure apparatus shown in FIG. 8.

FIG. 10 is a drawing schematically showing a construction of a conventional thin film coating apparatus.

### DESCRIPTION OF THE PREFERRED EMBODIMENT

### First Embodiment

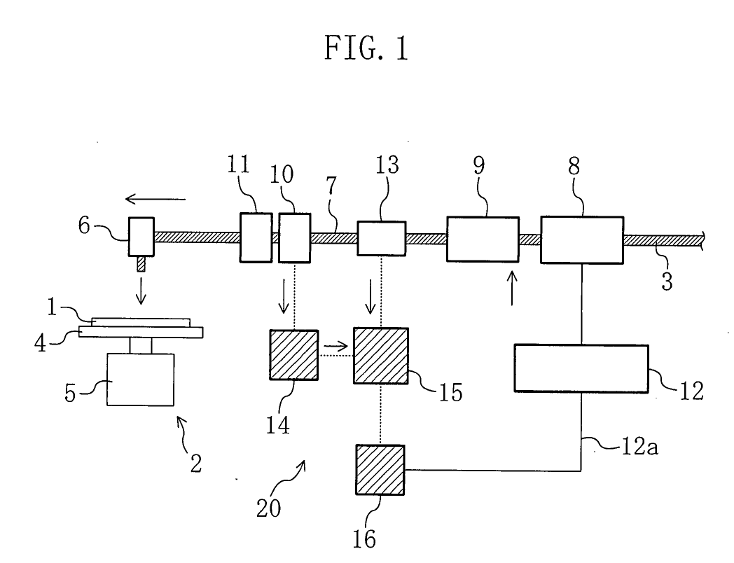

A first embodiment of the present invention will be described below in detail with reference to the drawings. FIG. 1 is a schematic drawing showing the construction of a thin film coating apparatus in the first embodiment of the present invention. The thin film coating apparatus in the present embodiment includes a wafer rotating mechanism 2 that holds horizontally and rotates a wafer 1, and a chemical solution application mechanism 20 that conveys and drops a chemical solution 3. The wafer rotating mechanism 2 is provided with a wafer chuck 4 that holds the wafer 1, and a motor flange 5 that rotates the wafer chuck 4. The chemical solution application mechanism 20 is provide with a discharge nozzle 6 that drops the chemical solution 3 onto the wafer 1, a pipe 7 that connects the discharge nozzle 6 with a delivery source (not shown) of the chemical solution 3, a pump provided in the middle of the pipe 7, a particle filtering unit 9, a particle measurement unit 13 that measures particles in the chemical solution 3, a solenoid control value 10, and a chemical solution level adjustment unit 11. The chemical solution level adjustment unit 11 serves to adjust the liquid level of the chemical solution 3 in the discharge nozzle 6 and has a function of sucking back the chemical solution 3 by applying negative pressure for preventing dripping of the chemical solution 3 from the tip end of the discharge nozzle 6 after discharge of a predetermined amount thereof. A controller 12 is provided further for controlling the chemical solution application mechanism 20, as described later, and only a part of a control line 12a thereof is shown for convenience sake. The particle measurement unit 13 detects particles included in the chemical solution 3 passing through the particle measurement unit 13 for a predetermined period, and integrates the thus detected number and the time period to output the result as data.

Difference of this thin film coating apparatus from the conventional one lies in that the apparatus additionally includes: a data collecting unit 15 which collects all time a control voltage value of the solenoid control valve 10 that opens/closes the pipe 7 and a measured value of the particle measurement unit 13; a voltage converter circuit 14 that voltage converts the control voltage of the solenoid control valve 10; and an arithmetic unit 16 that performs calculation of the measured value.

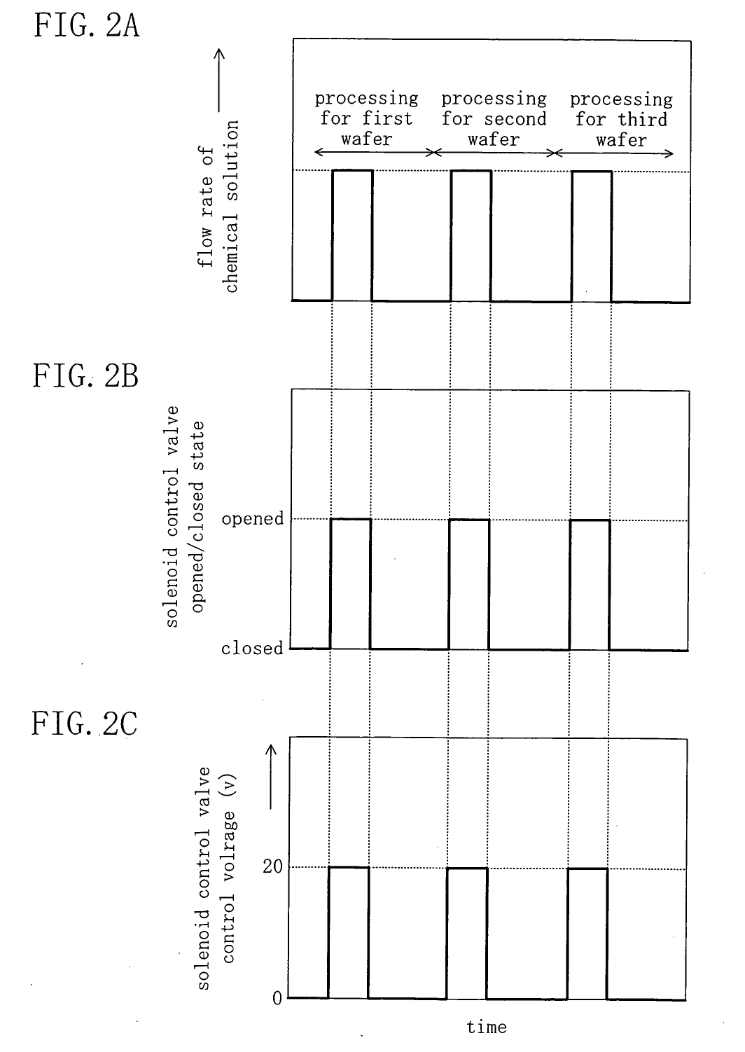

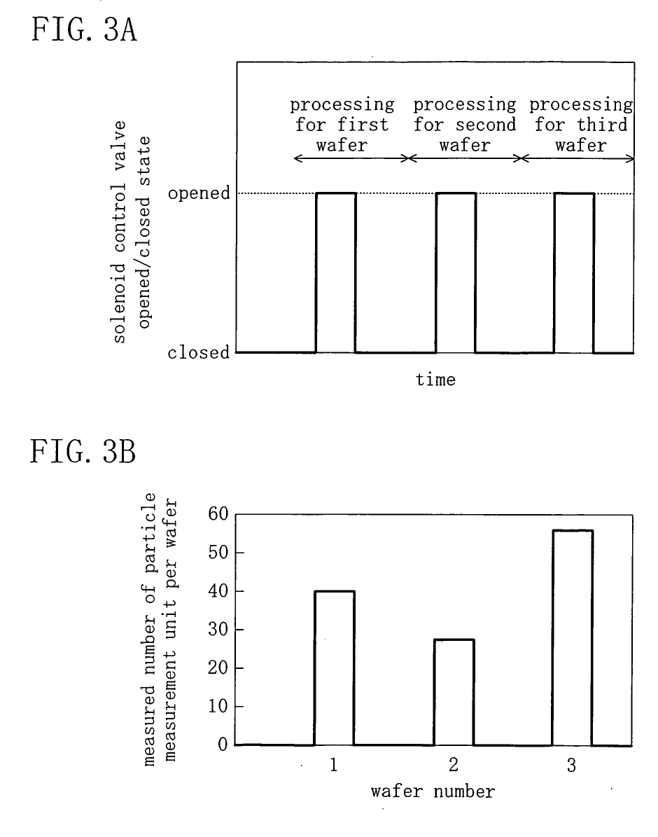

FIG. 2A to FIG. 2C are time charts showing a flow rate of the chemical solution 3 in the pipe 7 during wafer processing, opened/closed states of the solenoid control valve 10, and time variation of the control voltage value, respectively, in the first embodiment. The solenoid control valve 10 is closed when the apparatus is stopped and is in a standby state, while being opened to drive the pump 8 for discharging the chemical solution 3 when the chemical solution is flown in wafer processing. In this connection, only when the solenoid control valve 10 is opened as shown in FIG. 2B, the flow rate of the chemical solution 3 becomes constant as shown in FIG. 2C and the control voltage value for controlling the opening/closing operation of the solenoid control valve 10 changes from 0 v to 20 v. Also, when the chemical solution 3 is stopped flowing, the solenoid control valve 10 is closed, so that the control voltage value 10 changes from 20 v to 0 v. Accordingly, all time monitoring of the control voltage value of the solenoid control valve 10 enables grasping of a discontinuous discharge state of the chemical solution 3. It should be noted that the control voltage value of the solenoid control valve 10 herein changes between 0 v and 20 v, but it may change between arbitrary values only when the discharge state thereof can be grasped. Further, in some cases, direct input of a large voltage value, 20 v, to the data collecting unit 15 and the like is impossible according to specification (guaranteed performance of the data collecting unit 15 and the like) of the input element. In these cases, the control voltage value can be input to the data collecting unit 15 and the like in such a manner that a required control voltage of the solenoid control valve 10 is lowered to a desired voltage value through the voltage converter circuit 14.

A method of measuring particles in the chemical solution 3 in the present embodiment will be described next. FIG. 3A and FIG. 3B shows the relationship between the opened/closed states of the solenoid control valve 10 and the total number of particles in the chemical solution 3 to be applied on one wafer as a unit in the first embodiment. As shown in FIG. 3A, during the processing of one wafer, the chemical solution discharging operation is discontinuous and the solenoid control valve 10 repeats opening/closing operations. The number measured by the particle measurement unit 13 is taken into the data collecting unit 15 during the time when the solenoid control valve 10 is opened and the data is integrated in the arithmetic unit 16. This calculation leads to the total number of the particles in the chemical solution 3 per one-time discharge, that is, the chemical solution 3 to be discharged and dropped on a wafer as a unit. The calculation method will be described later in detail.

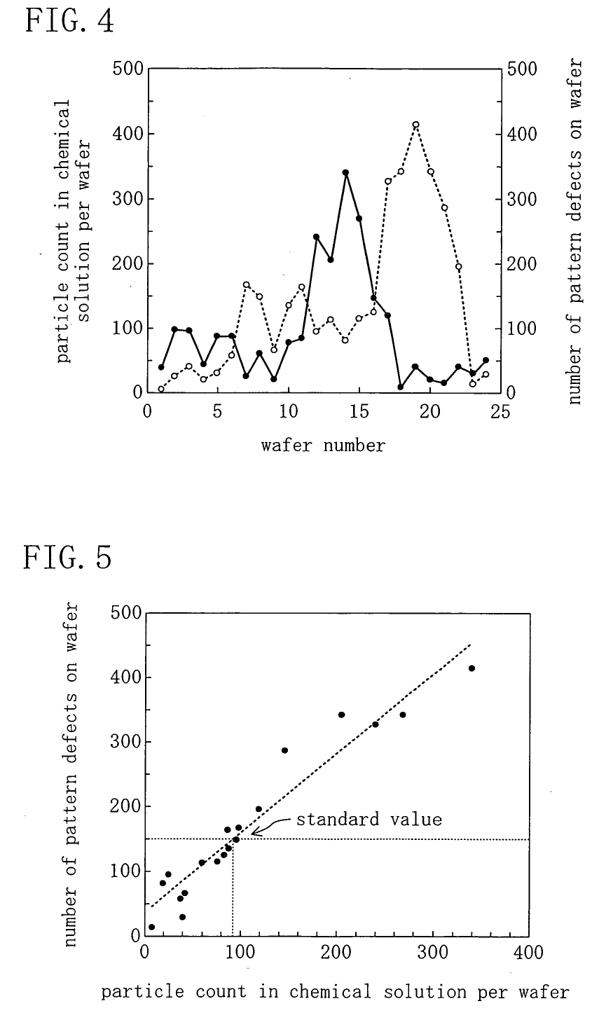

FIG. 4 is a graph showing each variation in the total number of particles in the chemical solution 3 to be applied on a wafer as a unit and in the number of pattern defects on the wafer in the first embodiment. As shown in FIG. 4, increase/decrease in the number of particles roughly accords with increase/decrease in the number of pattern defects with a difference by the number of processing times for five wafers. This is because the solenoid control valve 10, the chemical solution level adjustment unit 11, the discharge nozzle 6 and the pipe 7 that connects them exist between the particle measurement unit 13 and the tip end of the discharge nozzle 6. In detail, because the chemical solution 3 including the particles measured by the particle measurement unit 13 is dropped on a wafer only after passing through the solenoid control valve 10, the chemical solution level adjustment unit 11, the discharge nozzle 6, and the pipe 7 that connects them, taking time by time required for processing five wafers.

It is noted that the data shown in FIG. 4 indicates the measured result under the conditions that an apparatus is used in which the volume of the chemical solution 3 to be retained between the particle measurement unit 13 and the discharge nozzle 6, that is, the total capacity of the solenoid control valve 10, the chemical solution level adjustment unit 11, the discharge nozzle 6, and the pipe 7 that connects them, is 15 ml and that an amount of the chemical solution 3 discharged per one time is set to be 3 ml. In this case, the processing of five wafers causes the particles measured by the particle measurement unit 13 to pass from the particle measurement unit 13 to the discharge nozzle 6, and a lag at the discharge nozzle 6 becomes an interval by five-time processing. In this way, the interval of the particles measured by the particle measurement unit 13 until they reach the discharge nozzle 6 can be estimated using the total capacity between the particle measurement unit 13 and the discharge nozzle 6 and an amount of the chemical solution 3 to be discharged one time.

In view of the above knowledge, the correlation shown in FIG. 5 which takes account of the interval by five-time processing can be obtained. FIG. 5 is a graph showing a correlation between a measured value of the particle measurement unit 13 and the number of pattern defects on the wafer in the first embodiment.

Based on the correlation shown in FIG. 5, particle count corresponding to an arbitrary tolerance value of the number of pattern defects on a wafer is obtained and is determined as a standard value. Wherein, the “particle count” is a value obtained by summing the number of bubbles and the number of particles. Because both of them are causes of pattern defects on a wafer, they are referred to in combination. In FIG. 5, the particle count of 90 corresponds to the number of pattern defects on a wafer of 150, and is set as the standard value.

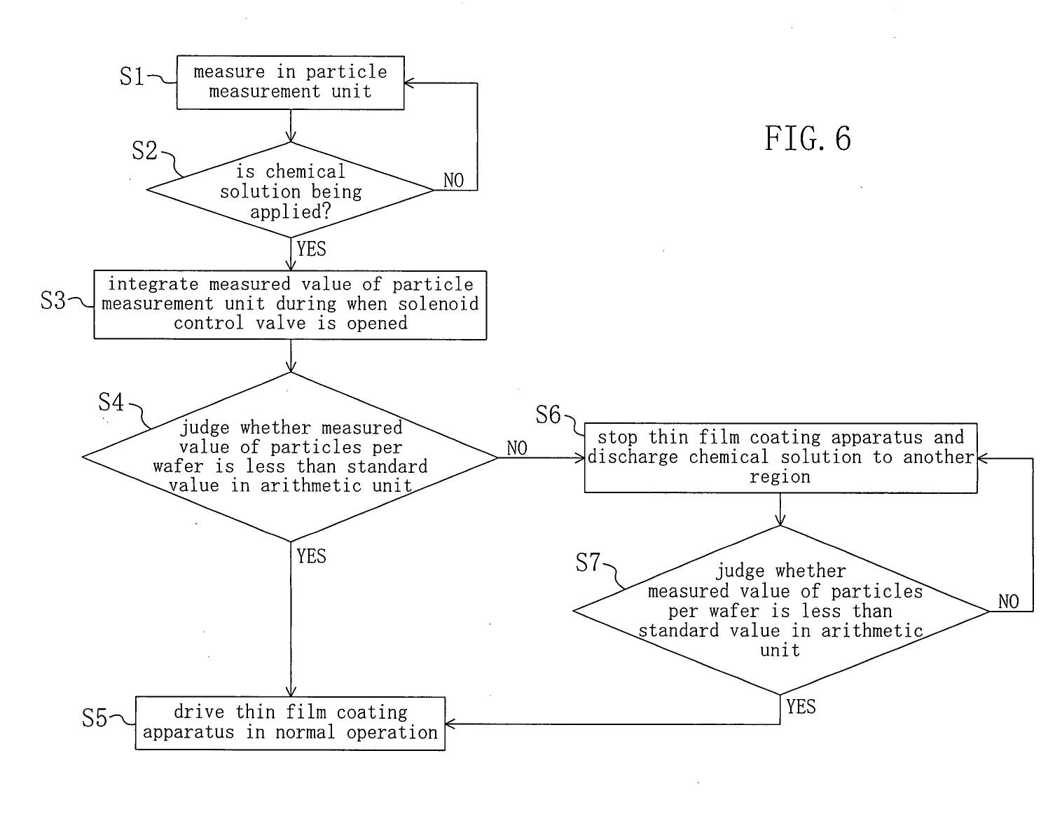

Control with the use of this standard value will be described with reference to FIG. 6. FIG. 6 is a flowchart depicting steps for controlling the thin film coating apparatus by referencing the standard value in the first embodiment. In the method in the present embodiment, the number of particles in the chemical solution 3 is measured in the particle measurement unit 13 in a step S1 and whether or not the chemical solution 3 is being applied is judged based on the control value of the solenoid control valve 10 in the data collecting unit 15 that takes the control voltage value of the solenoid control valve 10 in a step S2. When the judged result is that the chemical solution 3 is being applied, the measured result during the application of the chemical solution 3 measured by the particle measurement unit 13 is taken into the data collecting unit 15, and then, is integrated in the arithmetic unit 16 in a step S3.

Subsequently, in a step S4, judgment for comparing with the standard value the measured value integrated by the arithmetic unit 16, that is, the particle count included in the chemical solution 3 to be applied on a wafer as a unit (one-time discharge) is performed in the arithmetic unit 16. When the particle count is less than the standard value, a normal operation instruction is output in a step S5 so that the thin film coating apparatus is driven in a normal operation. While, when it is judged that the particle count exceeds the standard value, an abnormal operation stop instruction is output from the arithmetic unit 16 to the control unit 12 in a step S6 so that the thin film coating apparatus is stopped due to presence of abnormality and the chemical solution 3 is discharged through the discharge nozzle 6 to another region. At this time, the particles are discharged together with the chemical solution 3. In a step S7, the judgment for comparing the chemical solution 3 to be discharged with the standard value is performed in all time, likewise in the normal operation of the coating apparatus so that the thin film coating apparatus is driven normally when the particle count becomes less than the standard value and otherwise the solution discharge to the other region is continued when it exceeds the standard value.

In the present embodiment, when the chemical solution 3 includes many particles or bubbles accidentally by disturbance such as equipment trouble and flows into the chemical solution line, the thin film coating apparatus can be stopped automatically. In association, pattern defects of a resist can be prevented from being caused.

Further, the particles in the chemical solution 3 can be measured in real time while processing the wafer 1, and therefore, the normal/abnormal operations of the apparatus can be judged all time automatically. Hence, the operation time of an operator is reduced and the yield is improved in comparison with the conventional cases where the particles in a thin film is measured by the surface defect inspection system or the like after the thin film is formed on a monitor wafer. Moreover, the particles in the chemical solution 3 can be measured without interruption of the operation of the apparatus, with a result of increase in the availability ratio of the apparatus.

The chemical solution 3 is discharged to the other region automatically during the abnormal operation until the particle count becomes less than the standard value. Therefore, a more appropriate amount of the chemical solution 3 is discharged in comparison with the case where a given amount of solution is discharged by an operator. Moreover, check of the particle count in the chemical solution 3 while discharging the chemical solution 3 attains time reduction.

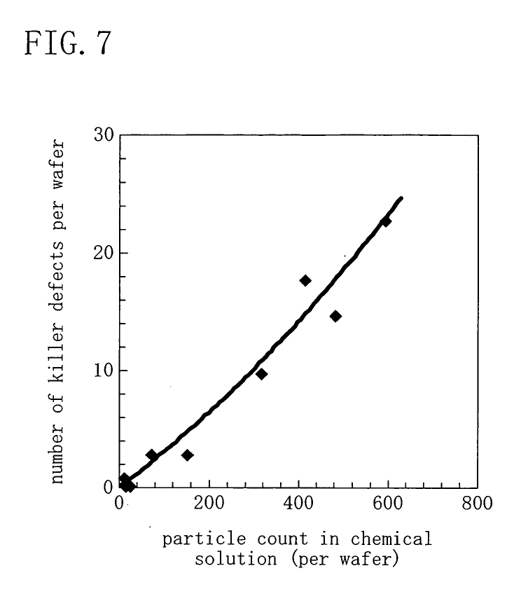

FIG. 7 is a graph showing the relationship between the particle count in the chemical solution 3 and the number of killer defects in a wafer as a unit in the first embodiment. The number of killer defects means the counted number of only defects that invite lowering of the device yield among pattern defects caused by particles in the chemical solution 3 in a device with a gate length of 0.15 μm having a pattern occupying rate of 54.4%. The relationship between the particle count and the number of the killer defects that invite yield lowering is understood from FIG. 7. Accordingly, appropriate setting of the standard value of the particle count embodies product processing under control of allowable number of killer defects.

### Second Embodiment

A second embodiment of the present invention will be described below with reference to drawings.

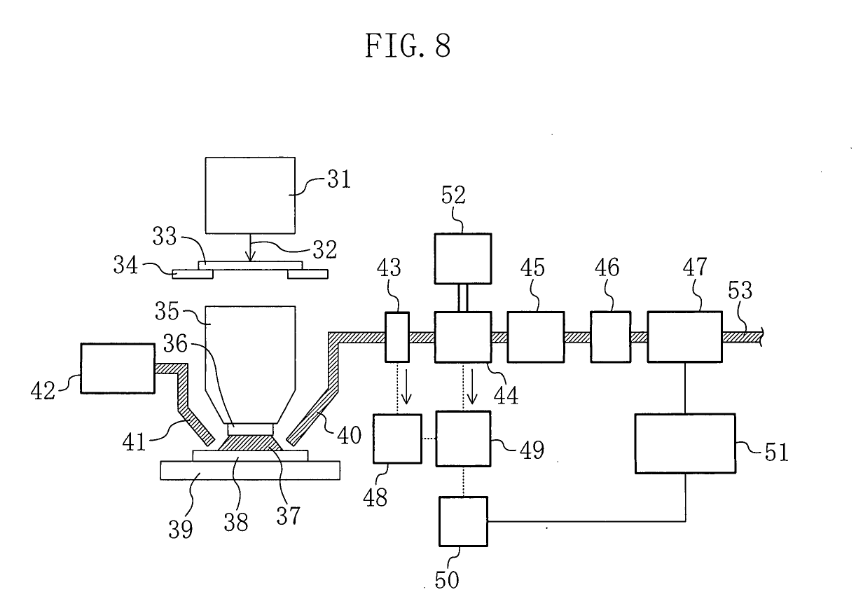

FIG. 8 is a schematic view illustrating an immersion exposure apparatus employing an immersion exposure method in a second embodiment. In the immersion exposure apparatus shown in FIG. 8, an illumination optical system 31 includes an exposure light source including an ArF excimer laser, a KrF excimer laser, and the like; an optical integrator; a field stop; condenser lens; and the like. Exposure light 32 emitted from the illumination optical system 31 illuminates a pattern provided on a reticle 33.

The reticle 33 is held by a reticle stage 34, and the pattern of the reticle 33 is reduction-projected, through a mirror cylinder 35 and a projection optical lens 36, on a wafer 38 on which a photoresist is applied.

The wafer 38 is placed on a wafer stage 39, and liquid 37 such as pure water is filled between the wafer 38 and the projection optical lens 36. The liquid 37 filled therebetween substantially shortens the wavelength of the exposure light 32, thereby increasing the resolution and substantially widening the depth of focus. The liquid 37 is supplied from a delivery source (not shown) of the liquid 37 through a pipe 35. In the pipe 53, there intervenes a pump 47, a particle filtering unit 46, a bubble removal unit 44 that removes bubbles in the liquid 37 selectively, a particle measurement unit 45 that measures particles such as bubbles in the liquid 37, a solenoid valve 43, and a liquid discharge nozzle 40 in this order when viewed from the supply source of liquid 37.

The bubble removal unit 44 not shown in detail has a structure of which inside is partitioned into two rooms by a special film permeable to gas with high selectivity. One of the two rooms is connected to the pipe 53 directly while the other room is connected to a vacuum pump 52. In the bubble removal unit 44, air in the other rooms is discharged by the vacuum pump 52 while the liquid 37 is allowed to pass through the room connected to the pipe 53. This causes the bubble included in the liquid 37 to pass through the film permeable to gas with high selectively, to move into the other room, and then, to be discharged outside by the vacuum pump 52.

The liquid 37 filled on the wafer 38 is returned through a liquid flow nozzle 41 to be regenerated by a liquid recovery unit 42 after exposure. Further, the present immersion exposure apparatus includes: a data collecting unit 49 that collects all time a control voltage value of the solenoid control valve 43 that opens/closes the pipe 53 and a measured value of the particle measurement unit 45; a voltage converter circuit 48 that voltage converts the control voltage of the solenoid control valve 43; an arithmetic unit 50 that performs calculation of the measured value of the particle measurement unit 45; and a control unit 51 that controls discharge/stop of the liquid 37.

In general immersion exposure apparatuses, particles such as bubbles in the liquid 37 on the wafer 38 scatter the exposure light 32, resulting in formation of a pattern not accorded with a reticle pattern. This causes pattern defects which may invite yield lowering. In the present embodiment, almost all particles and bubbles are filtered by the particle filtering unit 44 and bubbles still remaining after passing through the particle filtering unit 44 are removed by the bubble removal unit 44. Thus, pattern defects are prevented from causing further surely. It is noted that the bubble removal unit 44 selectively removes gaseous molecules only, as described above, so that the liquid 37 is not changed in its composition and flow rate.

Moreover, even if many bubbles enter into the liquid 37 accidentally by disturbance such as equipment trouble, the apparatus can be stopped while discharging the liquid 37 to another region automatically if the same particle measuring and control methods as described in the first embodiment are employed. The specific methods thereof will be described below. First, whether or not the liquid 37 is being supplied is judged in the data collecting unit 49 from the control voltage value of the solenoid control valve 10. When it is judged that the liquid 37 is being supplied, the measured result of the particle measurement unit 45 obtained during the time period when the liquid 37 is supplied is taken into the data collecting unit 49, and then, the measured result and the time period are integrated in the arithmetic unit 50.

Next, judgment for comparing with a standard value the measured value integrated in the arithmetic unit 50, that is, the particle count included in the liquid 37 to be supplied to a wafer as a unit (one-time discharge) is performed in the arithmetic unit 50. When the particle count is less than the standard value, a normal operation instruction is output so that the immersion exposure apparatus is driven in a normal operation. While, when it is judged that the particle count exceeds the standard value, an abnormal operation stop instruction is output from the arithmetic unit 50 to the control unit 51 so that the immersion exposure apparatus is stopped due to presence of abnormality and the liquid 37 is discharged through the discharge nozzle 6 to the other region. At this time, the particles are discharged together with the liquid 37. Herein, the judgment for comparing the liquid 37 to be discharged with the standard value is always performed, likewise in the normal operation of the immersion exposure apparatus so that the immersion exposure apparatus is driven normally when the particle count is less than the standard value and otherwise the liquid discharge to the other region is continued as long as it exceeds the standard value.

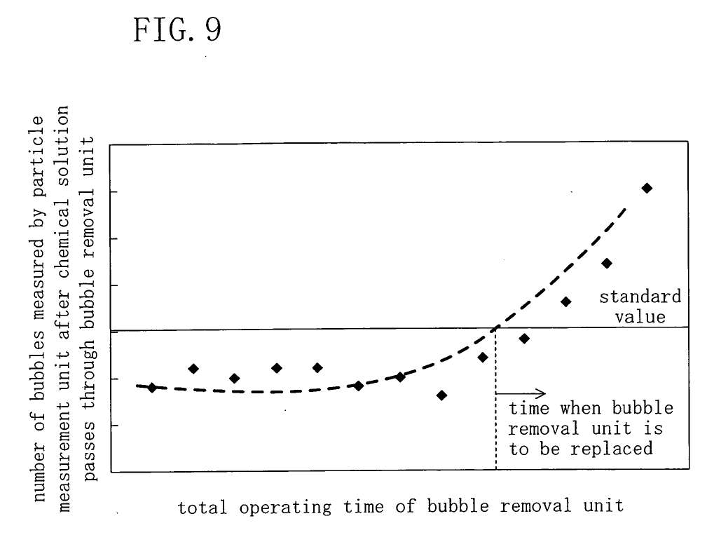

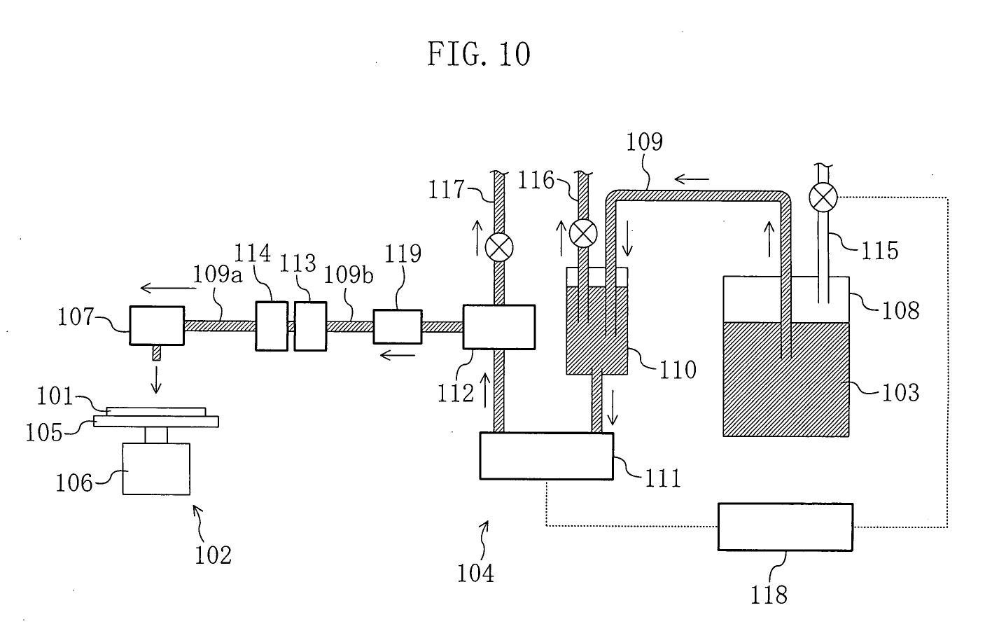

FIG. 9 is a graph showing the relationship between a sum of the operating time periods of the bubble removal unit 44 and a measured result of the number of particulate matters included in the liquid 37 after passing through the bubble removal unit 44, which is obtained by the particle measurement unit in the immersion exposure apparatus shown in FIG. 8. As the sum of the operating time periods of the bubble removal unit 44 becomes large, the ability to remove bubbles is lowered, with a result of increase in the number of bubbles in the liquid 37 after passing through the bubble removal unit 44. This necessitates replacement by a new bubble removal unit having the desired ability to remove bubbles. However, there is variation in amounts of bubbles and dissolved bubbles in the liquid 37 according to manufacture and conveyance conditions of the liquid 37, and it is not preferable to fix the replacement period. FIG. 9 shows gradual lowering of the ability to remove bubbles of the bubble removal unit after a given time period elapses. In this connection, the replacement timing of the bubble removal unit is estimated using, as a standard value, the measured value at the time when the ability to remove bubbles is lowered gradually after the given period elapses, and is set ahead of the lowering of the ability to remove bubbles. This enables replacement at appropriate timing even with variation in amounts of bubbles and dissolved bubbles in the liquid 37.

1. A thin film coating apparatus for forming a thin film in such a manner that a chemical solution supplied from a delivery source of the chemical solution through a particle filtering unit is discharged from a discharge nozzle so as to be applied on a surface of a wafer, comprising:
a pipe that connects the particle filtering unit and the discharge nozzle;
a solenoid control valve that opens/closes the pipe;
a particle measurement unit that measures a number of particulate matters included in the chemical solution in the pipe;
a data collecting unit that collects a control voltage value of the solenoid control valve and a measured value of the particle measurement unit; and
an arithmetic circuit that calculates a number of the particulate matters included in the chemical solution to be applied on the wafer as a unit from the control voltage value and the measured value which are collected in the data collecting unit.

2. The thin film coating apparatus of claim 1, wherein
the arithmetic circuit compares the number of the particulate matters included in the chemical solution to be applied on the wafer as a unit with a standard value determined in advance.

3. A thin film coating method using a thin film coating apparatus for forming a thin film in such a manner that a chemical solution supplied from a delivery source of the chemical solution through a particle filtering unit is discharged from a discharge nozzle so as to be applied on a surface of a wafer, comprising:
a step (a) of collecting a control voltage value of a solenoid control valve provided in a pipe that connects the particle filtering unit and the discharge nozzle and judging whether or not the chemical solution is being applied on the surface of the wafer;
a step (b) of measuring a number of particulate matters included in the chemical solution flowing in the pipe;
a step (c) of calculating a number of the particulate matters included in the chemical solution to be applied on the wafer as a unit based on results of the step (a) and of the step (b); and
a step (d) of judging based on a result of the step (c) whether or not the thin film coating apparatus is to be stopped.

4. The thin film coating method of claim 3, wherein
in the step (d), the judgment is performed by comparing the number of particulate matters included in the chemical solution to be applied on the wafer as a unit with a standard value predetermined in advance, and
the comparison of the number of particulate matters included in the chemical solution to be applied on the wafer as a unit with the standard value is continued even after it is judged that the thin film coating apparatus is to be stopped, and the thin film coating apparatus is stopped until it is judged that the number of the particulate matters falls within a normal range.

5. An immersion exposure apparatus for printing a mask pattern on a wafer from a tip end portion of an optical element of a projection optical system with a state that liquid is filled between the tip end portion of the optical element and a surface of the wafer, comprising:
a liquid discharge nozzle that supplies the liquid to the surface of the wafer;
a pipe that connects a delivery source of the liquid and the liquid discharge nozzle;
a solenoid control valve that opens/closes the pipe;
a particle filtering unit intervening in the middle of the pipe; and
a bubble removal unit which intervenes between the particle filtering unit and the liquid discharge nozzle in the pipe and removes bubbles in the liquid.

6. The immersion exposure apparatus of claim 5, further comprising:
a particle measurement unit which intervenes between the bubble removal unit and the liquid discharge nozzle in the pipe and measures a number of particulate matters included in the liquid;
a data collecting unit that collects a control voltage value of the solenoid control valve and a measured value of the particle measurement unit; and
an arithmetic circuit that calculates the number of particulate matters included in the liquid to be supplied on the wafer as a unit from the control voltage value and the measured value which are collected in the data collecting unit.

7. An immersion exposure method using an immersion exposure apparatus according to claim 5, comprising:
a step (a) of collecting the control voltage value of the solenoid control valve and judging whether or not the liquid is being supplied to the surface of the wafer;
a step (b) of measuring the number of particulate matters included in the liquid flowing in the pipe;
a step (c) of calculating the number of the particulate matters included in the liquid to be supplied to the wafer as a unit based on results of the step (a) and of the step (b); and
a step (d) of judging based on a result of the step (c) whether or not the immersion exposure apparatus is to be stopped.

8. The immersion exposure method of claim 7, wherein
in the step (d), the judgment is performed by comparing the number of particulate matters included in the liquid to be supplied to the wafer as a unit with a standard value predetermined in advance, and
the comparison of the number of particulate matters included in the liquid to be supplied to the wafer as a unit with the standard value is continued even after it is judged that the immersion exposure apparatus is to be stopped, and the immersion exposure apparatus is stopped until it is judged that the number of the particulate matters falls within a normal range.
